(19) United States
(12) Patent Application Publication
(10) Pub. No.: US 2014/0170630 A1
(43) Pub. Date: Jun. 19, 2014

(54) LEARNING CONTENT-PROVIDING METHOD

(71) Applicant: Teracle, Inc., Seoul (KR)

(72) Inventors: In Je CHO, Seoul (KR); Min Kyu KIM, Seoul (KR); Sung Joong LIM, Anyang-si (KR)

(73) Assignee: Teracle, Inc., Seoul (KR)

(21) Appl. No.: 14/104,947

(22) Filed: Dec. 12, 2013

(30) Foreign Application Priority Data
Dec. 14, 2012 (KR) 10-2012-0146323
Nov. 18, 2013 (KR) 10-2013-0140086

(51) Int. Cl. G09B 7/06

(52) U.S. Cl. CPC G09B 7/06
USPC 434/362

(57) ABSTRACT

Provided is a method of providing learning contents by a server. The method includes providing a list of steps of review contents to a user terminal; receiving a selection of a step on the list of the steps of the review contents from the user terminal, and providing the review contents of the selected step to the user terminal; and providing a point score according to a learning performance on each step of the review contents by a user, and an evaluation score according to a correct answer rate, to the user terminal.

### RELATED APPLICATIONS

This application claims the benefit of Korean Patent Applications No. 10-2012-0146323, filed on Dec. 14, 2012, and No. 10-2013-0140086, filed on Nov. 18, 2013, in the Korean Intellectual Property Office, the disclosures of which are incorporated herein in its entirety by reference.

### BACKGROUND

1. Field of the Invention

One or more embodiments of the present invention relate to a learning content-providing method, and more particularly, to a learning content-providing method in which, after taking an offline or online video lesson of each unit for each subject, a learner may perform a step-by-step review of the unit by using a user terminal.

2. Description of the Related Art

As a communication technology has advanced recently, learning contents, which allow learning by using the internet or a mobile communication network, are provided in various ways.

Particularly, an online learning system provides a video lesson so that a learner may be provided with a high-level learning service regardless of time and place.

However, since an online learning system, which is used currently, provides only a video lesson or a lesson plan, the learner may not be encouraged to study systematically by him/herself.

In the case of an offline lesson, the learner needs to do a review after taking a lesson, by using a material that is used for the lesson or purchasing a new material. Thus, it costs a lot of money and, unless the learner makes a plan and study systematically by him/herself, a learning achievement may not be improved.

### SUMMARY OF THE INVENTION

One or more embodiments of the present invention include a method of solving such a problem. The method is to improve achievements of a learner by encouraging the learner to do a review of each unit simply, systematically, and repeatedly at a certain interval regardless of time and place by using a portable terminal after taking an offline or online lesson in each unit for each subject.

One or more embodiments of the present invention include a method in which, after a learner does a review by using a portable terminal, wrong-answered questions are collected from the review and a wrong answer note is generated, so that a learner may repeatedly work on wrong-answered questions after doing a review. Additionally, questions with a high wrong answer rate (for example, higher than 30%) of a higher scorer, for example, a learner with a score in a top 10% among learners who learned a unit of a subject, are automatically collected, and a wrong answer note of the higher scorer is generated. Thus, the learner may study by comparing the higher scorer's wrong answer note to the learner's wrong answer. Accordingly, an efficiency of repeated learning may be maximized.

Additional aspects will be set forth in part in the description which follows and, in part, will be apparent from the description, or may be learned by practice of the presented embodiments.

According to one or more embodiments of the present invention, a method of providing learning contents by a server includes providing a list of steps of review contents to a user terminal; receiving a selection of a step on the list of the steps of the review contents from the user terminal, and providing the review contents of the selected step to the user terminal; and providing a point score according to a learning performance on each step of the review contents by a user, and an evaluation score according to a correct answer rate, to the user terminal.

Difficulty levels and appropriate learning periods of the steps of the review contents may be differently set

Each step of the review contents may be performable after the review contents of a previous step are learned.

The method may further include providing an alarm to the user terminal in the set appropriate learning periods.

The steps of the review contents may be displayed as different icons according to whether learning is performed and the learning performance.

The point score may be calculated based on a period of learning the review contents of each step, and a number of times that the review contents are learned.

The providing of the point score may include providing a review ranking of the user determined according to a result of accumulating the point scores, to the user terminal.

The method may further include receiving a request for my wrong answer note, or other people's wrong answer note based on results of learning review programs by members registered to the server, from the user terminal, and providing the wrong answer note to the user terminal.

The other people's wrong answer note may be generated based on questions each of which a correct answer rate of the members registered to the server is within a certain range, or wrong answer questions of the members whose evaluation scores are within a certain range.

The providing of the wrong answer note may include receiving a request to delete a wrong answer question from my wrong answer note or to add a wrong answer question of the other people's wrong answer note to my wrong answer note, from the user terminal, and updating my wrong answer note by deleting or adding the requested wrong answer question from or to my wrong answer note.

According to one or more embodiments of the present invention, a learning content-providing apparatus, comprising: a review program-providing module for providing a list of steps of review contents to a user terminal, receiving from the user terminal a selection of a step from the list of the steps of the review contents, and providing review contents of the selected step to the user terminal; and an evaluation module for providing a point score according to a learner's learning performance on each step of the review contents, and an evaluation score according to a correct answer rate to the user terminal.

Difficulty levels and learning periods of at least one of the steps of the review contents are differently set.

Each step of the review contents is performable after the review contents of a previous step have been learned.

The review program-providing module provides an alarm to the user terminal in the set learning periods.

The steps of the review contents are displayed as a plurality of icons according to whether learning has been performed and the learning performance.

The point score is calculated based on a period of learning the review contents of each step, and a number of times that the review contents are learned.

The evaluation module determines a review ranking of the learner according to a result of accumulated point score, and provides the review ranking to the user terminal.

The apparatus further comprising a wrong answer note generation module for receiving from the user terminal a request for my wrong answer note, or at least one of other people's wrong answer notes that is based on results of learning review programs by members who are registered to the server, and providing my wrong answer note or the at least one of other people's wrong answer notes to the user terminal.

The at least one of other people's wrong answer notes is generated based on questions each of which a correct answer rate of the members registered to the server is within a certain range, or wrong answer questions of the members whose evaluation scores are within a certain range.

The wrong answer note generation module receives from the user terminal a request for deleting a wrong answer question from the my wrong answer note or adding a wrong answer question of the at least one of other people's wrong answer notes to the my wrong answer note, and updates the my wrong answer note by deleting or adding the requested wrong answer question from or to the my wrong answer note.

A computer-readable storage medium having stored thereon a computer program, which when executed by a computer, performs one of the methods.

### BRIEF DESCRIPTION OF THE DRAWINGS

These and/or other aspects will become apparent and more readily appreciated from the following description of the embodiments, taken in conjunction with the accompanying drawings in which:

FIG. 1 is a diagram illustrating a learning content-providing system according to an embodiment of the present invention;

FIG. 2 is a schematic block diagram of a configuration of a learner terminal for executing a learning content application according to an embodiment of the present invention;

FIG. 3 is a flowchart for illustrating a process, performed by the learner terminal, of performing a review by using the learning content application according to an embodiment of the present invention;

FIGS. 4A through 4E are examples of a screen in which a review is performed by the learner terminal through the learning content application according to an embodiment of the present invention;

FIG. 5 is a flowchart for illustrating a process, performed by the learner terminal, of displaying a wrong answer note via the learning content application according to an embodiment of the present invention;

FIGS. 6A through 6C are examples of a screen in which the learner terminal displays the wrong answer note via the learning content application according to an embodiment of the present invention;

FIGS. 7A through 7B are examples of a screen in which the learner terminal displays a learning diagnosis result via the learning content application according to an embodiment of the present invention;

FIGS. 8A through 8C are examples of a screen in which the learner terminal displays a review ranking among members of the learning content application according to an embodiment of the present invention;

FIG. 9 is a schematic block diagram of a configuration of the learning content-providing server according to an embodiment of the present invention;

FIG. 10 is a flowchart for illustrating a method, performed by the learning content-providing server, of providing learning contents according to an embodiment of the present invention; and

FIGS. 11A through 11J are examples of menu screens that are provided, by the learning content-providing server, to the learner terminal.

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the description of the present invention, certain detailed explanations of related art are omitted when it is deemed that they may unnecessarily obscure the essence of the invention.

While such terms as “first,” “second,” etc., may be used to describe various components, such components must not be limited to the above terms. The above terms are used only to distinguish one component from another. An expression used in the singular encompasses the expression of the plural, unless it has a clearly different meaning in the context.

The terms used in the present specification are merely used to describe particular embodiments, and are not intended to limit the present invention. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

According to embodiments of the present invention, terms such as “communication”, “communication network”, “internet network”, and “network” may have the same meaning. Such terms mean a wired or wireless near-field and wide-area data transceiving network for transceiving a file between a user terminal, terminals of other users, and a download server.

Hereinafter, the present invention will be described in detail by explaining preferred embodiments of the invention with reference to the attached drawings. Like or corresponding reference numerals in the drawings denote like elements, and thus their description will be omitted.

FIG. 1 is a diagram illustrating a learning content-providing system according to an embodiment of the present invention.

Referring to FIG. 1, according to an embodiment of the present invention, the learning content-providing system includes a learner terminal (or a user terminal) 100 and a learning content-providing server 200.

The learner terminal 100 is connected to the learning content-providing server 200, and thus downloads and installs a learning content application that is used for review.

Then, the learner terminal 100 executes the learning content application to be connected to the learning content-providing server 200. Then, the learner terminal 100 receives a pre-registered review program (review contents) for each step in each unit of each subject from the learning content-providing server 200, and displays the review program. The review program may include lesson contents and test questions for each unit in the form of text, images, and video clips.

The review program is executed respectively for each unit in each subject. Each unit includes a plurality of review programs in each step. Review programs in each step may vary with a setting made by a learner or a manager.

According to an embodiment of the present invention, the review program may be set to include a first review program in which a review may be done during a recess time for 10 minutes after a lesson for each unit is finished, and second and third review programs in which a review may be done for a certain period of time after the first review program is finished, according to a learning schedule of each unit, which is pre-input by the learner or the manager. The second review program is a program in which lessons in a plurality of units, which have been taken online or offline, may be reviewed together within two days after the first review program is finished. The third review program is a program in which lessons in a plurality of units, which have been taken online or offline, may be reviewed together within one week after the first review program is finished. Since the first review program needs to be finished in a recess time for 10 minutes immediately after an online or offline lesson is finished, a timer may be set to perform the first review program.

According to another embodiment of the present invention, an appropriate period of performing a review program in each step is preset by a manager, and a learner performs the review program in each step when the review program may be performed after an online or offline lesson is finished. Then, a time difference between the preset appropriate period of performing the review program and a period in which the learner performed the review program for each unit is calculated, and thus, taken into account for calculating a point score that is provided when performing the review program for each step is finished. In this case, the learner may reduce time stress in performing the review program. Additionally, even if a preset period of performing the review program has elapsed, the learner may be encouraged not to give up but to keep performing the review program.

Additionally, the learner terminal 100 may receive a wrong answer note, which is generated based on a result of which the learner or another high scorer performed the review program for each subject, from the learning content-providing server 200, and then display the wrong answer note.

The learner terminal 100 may receive a wrong answer note for each review step or unit of the corresponding subject according to a selection made by the learner from the learning content-providing server 200, and display the wrong answer note.

Additionally, the learner terminal 100 may check a review time through a timer menu that is included in the learning content application. The learner terminal 100 may provide an alarm in an appropriate performing period that is set for the review program.

The learning content-providing server 200 is connected to the learner terminal 100 via a communication network, and is also connected to a database 250.

The database 250 may include a membership information database 210 for a member who is registered for the learning content application, a video lesson database 220 in which a video lesson in each unit for each subject is stored, and a review program database 230 in which a review program and a wrong answer note in each step of each unit of each subject are stored.

The learning content-providing server 200 may match membership information about a member with information about a video lesson that is downloaded by the member and information about a review program that is performed by the member. The information about the review program that is performed by the member includes a score and wrong answer information with regard to the review program that is performed by the member. If it is set to provide a point score whenever the member finishes a review program in each step in each unit, the information about the review program that is performed by the member may include a total point score of the member.

According to a setting made by a manager, an accumulated point score may be used to pay for a charged video lesson or other charged products.

The learning content-providing server 200 transmits the learning content application to the learner terminal 100.

In order to easily compare statuses of reviews that are performed by members with each other according to a setting made by a manager, the learning content-providing server 200 may be set so that, when performing of a review program is finished, a level of a member may be raised to a certain degree.

When receiving login information from the learner terminal 100, the learning content-providing server 200 checks if the login information is for a registered member and, if the login information is for a registered member, authorizes the login.

Then, the learning content-providing server 200 transmits a list of subjects, which are pre-registered by a learner whose login is authorized, to the learner terminal 100.

When receiving a request for performing a review program of a subject from among the list of the subjects from the learner terminal 100, the learning content-providing server 200 transmits a list of units of the requested subject and a list of review programs for each step, which are included in each unit, to the learner terminal 100.

The learning content-providing server 200 receives a request for transmitting a specific review program in a specific unit from the learner terminal 100, and transmits the requested specific review program in the specific unit to the learner terminal 100.

Then, when performing of the specific review program in the specific unit is finished, the learning content-providing server 200 provides a preset point score to a learner, that is, the member.

If it is determined that three steps of the review program in the specific unit are all finished, the learning content-providing server 200 assigns a high evaluation index for the learner.

Additionally, when receiving a request for generating a wrong note for each subject from the learner terminal 100, the learning content-providing server 200 generates a wrong answer note for each review step or unit with regard to the corresponding subject based on wrong answer information of the corresponding learner, and transmits the wrong answer note to the learner terminal 100.

Additionally, when receiving a request for generating a wrong answer note of a high scorer from the learner terminal 100, the learning content-providing server 200 generates a wrong answer note of a high scorer from among the members for each review step or unit of the corresponding subject based on wrong answer information of the high scorer.

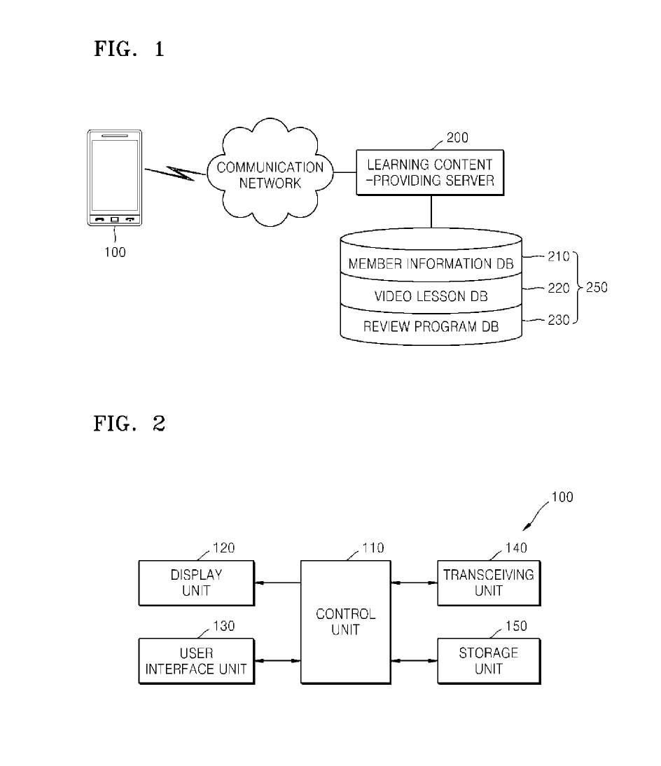

FIG. 2 is a schematic block diagram of a configuration of the learner terminal for executing a learning content application according to an embodiment of the present invention.

The learner terminal 100 may be a laptop computer, a hand-held apparatus, a mobile terminal such as a smartphone or a tablet personal computer (PC), a desktop computer, or an appropriate arbitrary apparatus that uses or is directly or indirectly connected to the above-mentioned apparatuses.

Referring to FIG. 2, the learner terminal 100 includes a control unit 110, a display unit 120, a user interface unit 130, a transceiving unit 140, and a storage unit 150.

The control unit 110 controls all operations of the learner terminal 100 and, when the learning content application is executed, transmits login information to the learning content-providing server 200.

When login is authorized by the learning content-providing server 200, the control unit 110 receives a list of subjects, which are pre-registered by the learner, from the learning content-providing server 200, and displays the list of the subjects.

Then, when receiving an input of a selection of one subject, from among the displayed list of the subjects, from the learner, the control unit 110 receives a list of units of the selected subject and a list of steps of a review program that is included in each unit from the learning content-providing server 200, and displays the received lists.

Then, when receiving an input of a selection of a step of a specific review program in a specific unit in the display list of the units from the learner, the control unit 110 requests the learning content-providing server 200 for a review program in the selected step. Then, the control unit 110 receives a review program in the corresponding step from the learning content-providing server 200, and displays the transmitted review program.

Additionally, when the learner selects a wrong answer note menu, the control unit 110 requests the wrong answer note to the learning content-providing server 200, and then, receives a wrong answer note for each subject, which the learner reviewed, from the learning content-generating server 200, and displays the wrong answer note for each subject.

When the learner selects a specific subject from the wrong answer note for each subject, the control unit 110 receives a wrong answer note, which includes wrong answers that are generated after a review is done with regard to the corresponding subject, from the learning content-providing server 200, and displays the received wrong answer note.

According to a selection made by the learner, the control unit 110 receives a wrong answer note for each review step of the corresponding subject or a wrong answer note for each unit of the corresponding subject from the learning content-providing server 200, and displays the received wrong answer note.

Additionally, when the learner selects a request for displaying a wrong answer note of a high scorer in the wrong answer note menu, the control unit 110 requests a wrong answer note of a high scorer to the learning content-providing server 200. Then, the control unit 110 receives a wrong answer note, which is generated based on wrong answer information of members who correspond to high scorers among members who have performed a review program, from the learning content-providing server 200, and displays the received wrong answer note. The wrong answer note of a high scorer may be a wrong answer note for each review step of the corresponding subject or a wrong answer note for each unit of the corresponding subject.

The display unit 120 displays a screen in which the learning content application is executed. The display unit 120 may include at least one from among a liquid-crystal display (LCD), an organic light-emitting display (OLED), an electrophoretic display (EPD), a flexible display, and a three-dimensional (3D) display. According to an implementation type of the learner terminal 100, two or more display units 120 may be provided.

The user interface unit 130 provides an interface with a user for controlling an operation of the learner terminal 100. Particularly, the user interface unit 130 receives an input of a manipulation signal from the learner who is to do a review by using the learning content application, and transmits the manipulation signal to the control unit 110.

The transceiving unit 140 transmits and receives data, particularly, data relating to execution of the learning content-application with the learning content-providing server 200.

The storage unit 150 stores the learning content application and a downloaded video lesson. The storage unit 150 stores a result of the learner's performance on the questions and a ranking of the result. The storage unit 150 may include at least one type of storage medium from among a flash memory type, a hard disk type, a multimedia card micro type, a card-type (for example, secure digital (SD) or extreme digital (XD) memory), a random-access memory (RAM), and a read-only memory (ROM).

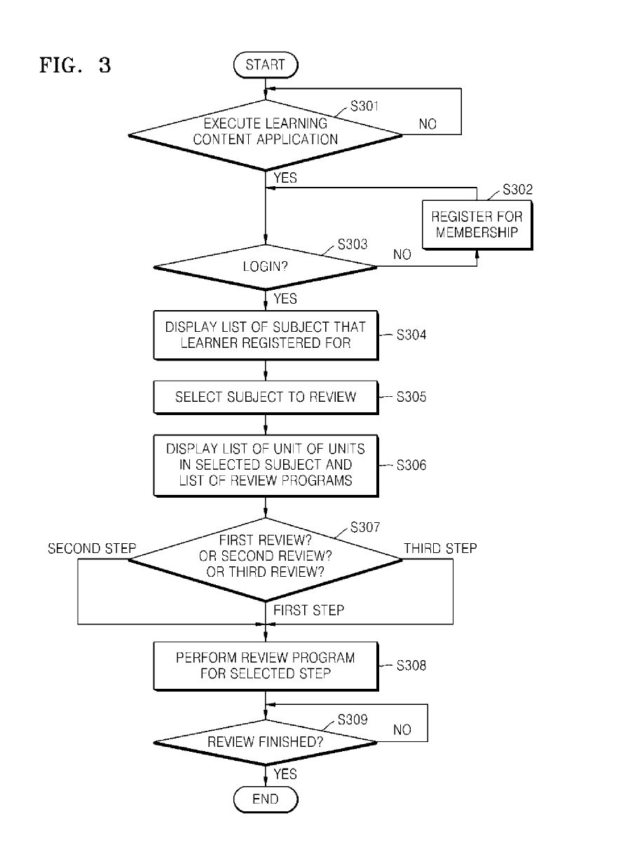

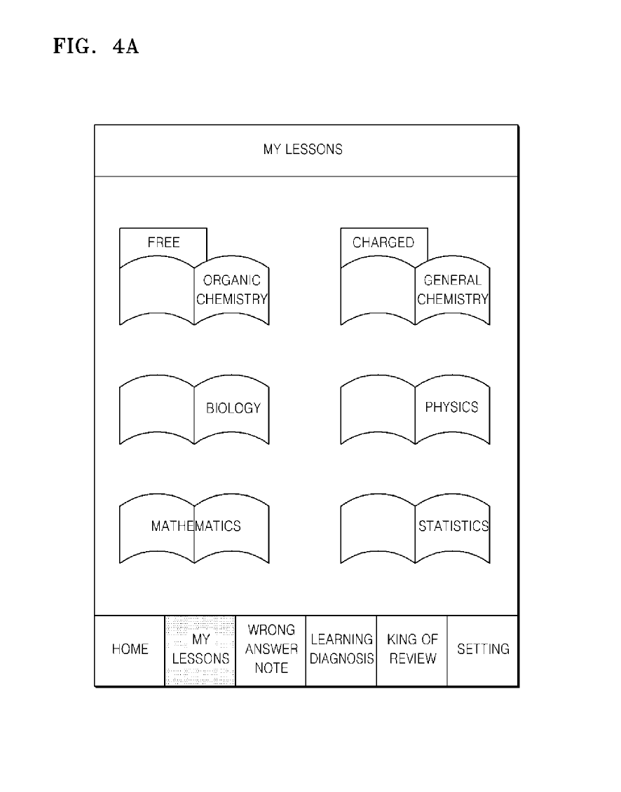

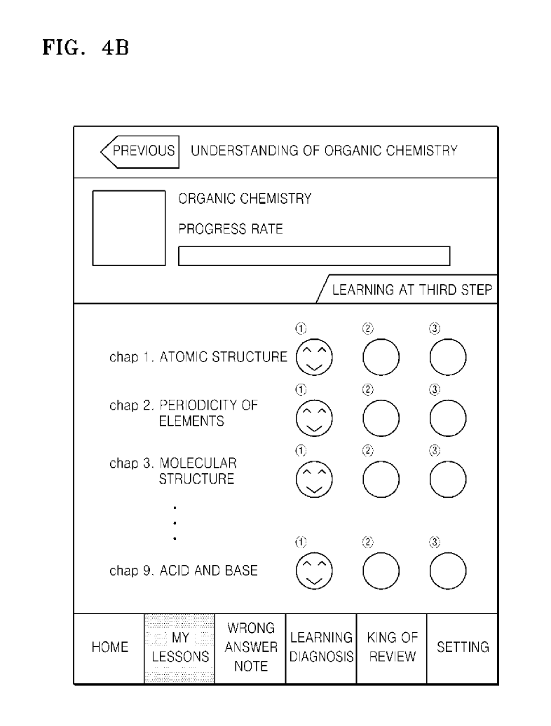

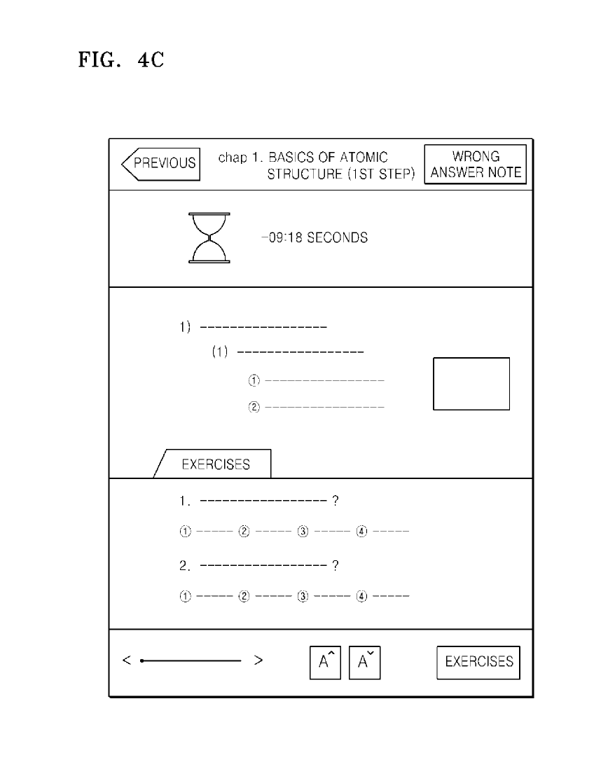

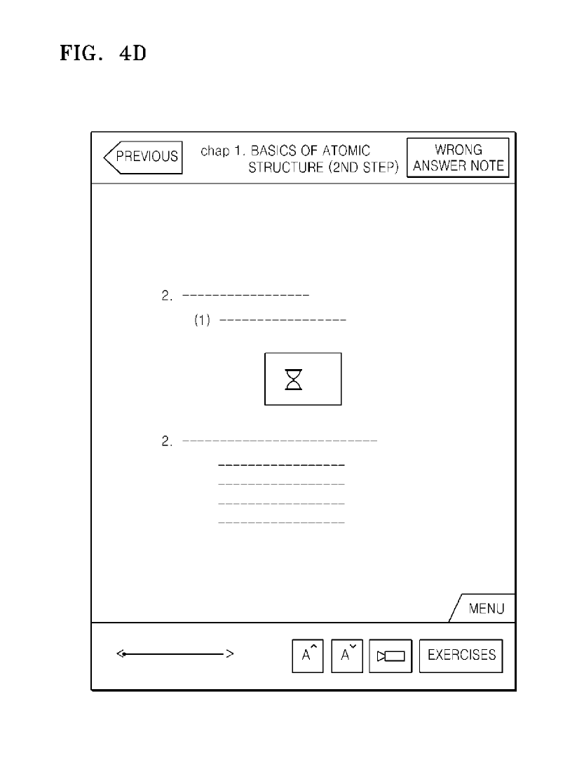

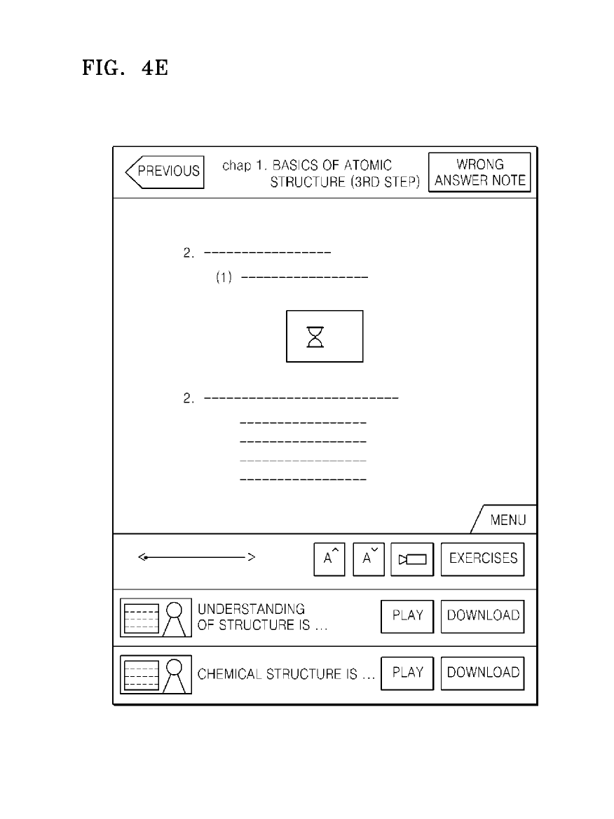

FIG. 3 is a flowchart for illustrating a process, performed by the learner terminal 100, of performing a review through the learning content application according to an embodiment of the present invention. FIGS. 4A through 4E are examples of a screen in which a review is performed by the learner terminal 100 through the learning content application according to an embodiment of the present invention.

Referring to FIGS. 3 and 4A through 4E, when the learning content application is executed in operation S301, the control unit 110 receives an input of an identification (ID) and a password, which are registered when a learner is registered for a membership, from the learner, and requests the learning content-providing server 200 for login by using the received input ID and password, in operation S303.

In operation S302, if the learner is not registered for the membership, the control unit 110 executes a procedure for registering the learner for the membership.

As shown in FIG. 4A, when login is authorized by the learning content-providing server 200, the control unit 110 receives a list of subjects, which is for a logged-in member, that is, a learner registered for, from the learning content-providing server 200, and displays the list of the subjects in operation S304. Alternately, the control unit 110 may display a list of subjects registered for by the learner, and further display subjects that have not been registered for, but may be currently available for registration by the learner.

When the learner selects a subject that is to be reviewed from the displayed list of the subjects, the control unit 110 requests the learning content-providing server 200 for a review program of the selected subject in operation S305. Then, in operation S306, the control unit 110 receives a list of units in the selected subject and a list of review programs for each step in each unit, and displays the received lists.

For example, as shown in FIG. 4B, the control unit 110 may display a list of steps of the review program in each unit. As shown in FIG. 4B, the list of the steps of the review program may be displays as an icon. The steps of the review contents may be displayed as different icons respectively according to whether the review program is performed and a progress rate of the review program.

When receiving a selection of the step of the review program in a unit, which is to be reviewed, in the displayed list of the units and the list of the steps of the review programs from the learner, the control unit 110 requests the learning content-providing server 200 to execute the selected review program in operation S307.

Then, in operation S308, the control unit 110 may receive the selected review program in the selected unit from the learning content-providing server 200, and display the selected review program as shown in FIGS. 4C through 4E, and the learner may perform the review program.

The review program is executed for each step. Desirably, a second review program may be executed within a predetermined period after a first review program is finished, and a third review program may be executed within a predetermined period after the first review program is finished.

The control unit 110 may transmit a result of the performing of the review program to the learning content-providing server 200, and receive an evaluation score and a point score with regard to the result of the performing of the review program from the learning content-providing server 200, and display the evaluation score and the point score.

The control unit 110 transmits a result of performing a question in the review program to the learning content-providing server 200, and receives and displays whether the question is correct or incorrect from the learning content-providing server 200. Additionally, the control unit 110 may transmit a result of performing all questions of the review program to the learning content-providing server 200, and receive an evaluation score with regard to all the questions from the learning content-providing server 200 and display the evaluation score.

The control unit 110 may receive a point score, which is calculated based on a period of performing the review program and a number of times that the review program is performed, from the learning content-providing server 200, and display the point score. A score that is obtained by adding a newly-provided point score to a previously-provided point score may be displayed.

When the review program is finished, the control unit 110 stands-by to wait for whether another menu selection is made in operation S309.

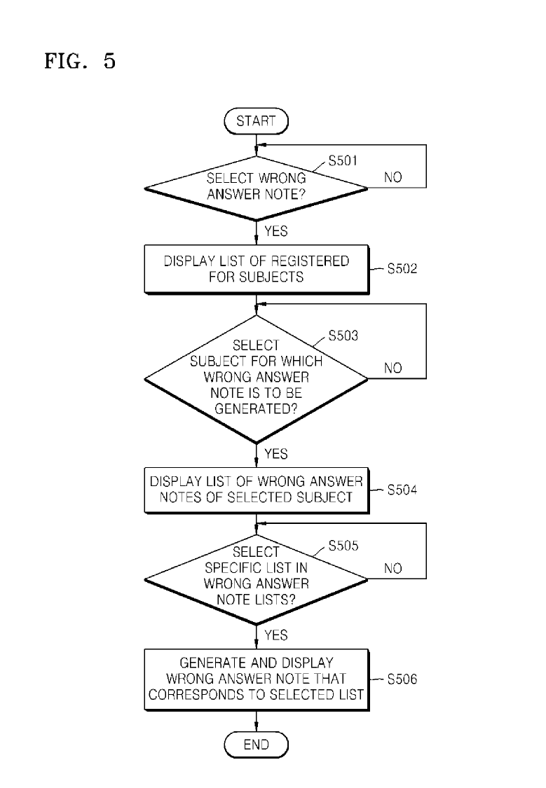

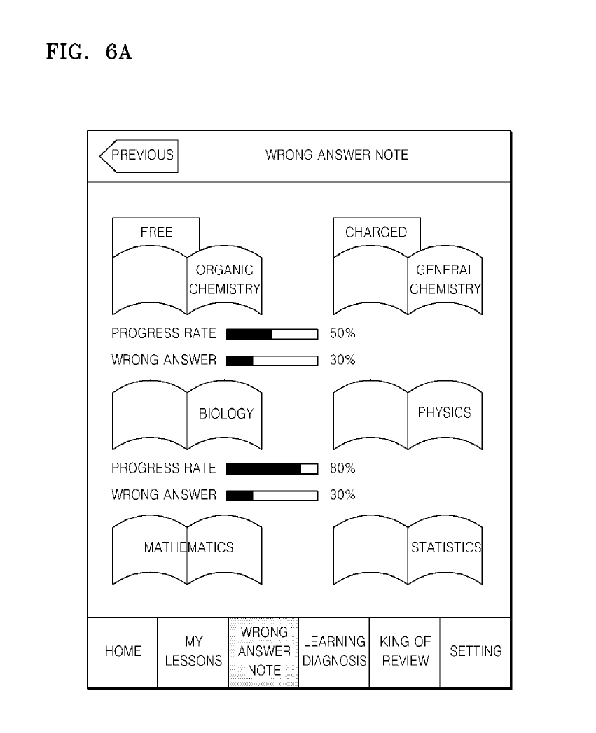

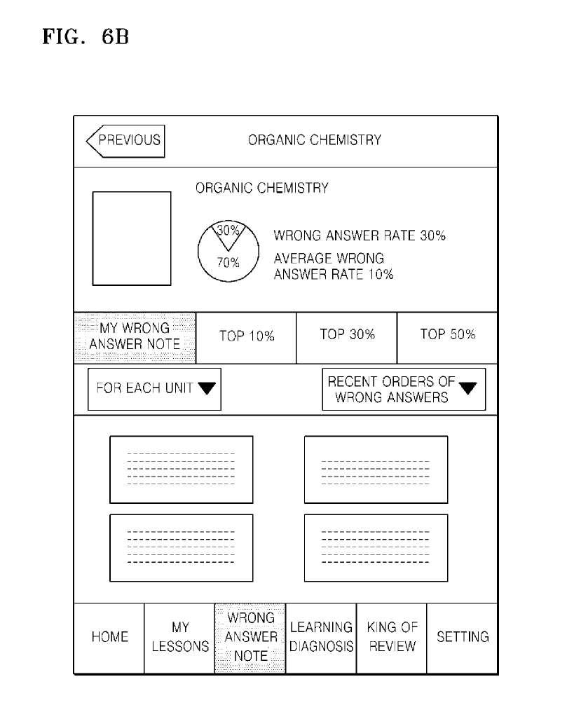

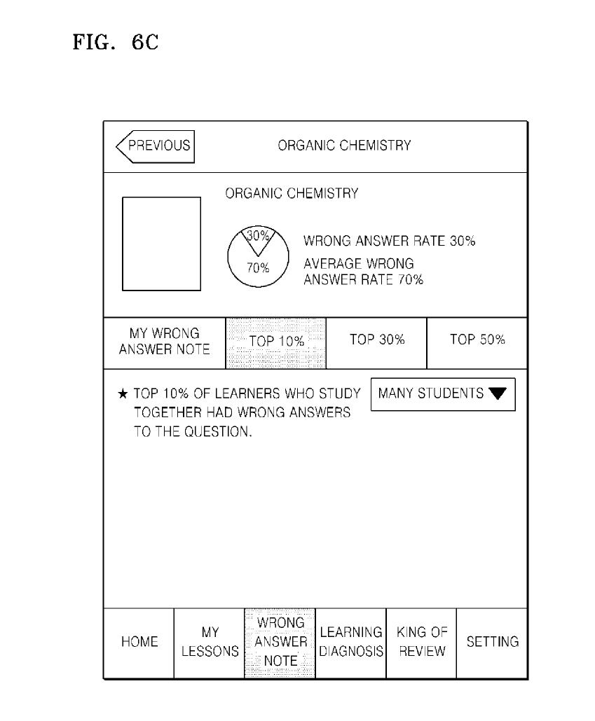

FIG. 5 is a flowchart for illustrating a process, performed by the learner terminal 100, of displaying a wrong answer note via the learning content application according to an embodiment of the present invention. FIGS. 6A through 6C are examples of a screen in which the learner terminal 100 displays the wrong answer note via the learning content application according to an embodiment of the present invention.

Referring to FIGS. 5 and 6A through 6C, when the control unit 110 receives a selection of a wrong answer note menu from the learner in operation S501, the control unit 110 may receive a list of subjects that the learner is registered for, and a review progress rate and a wrong answer rate of each subject from the learning content-providing server 200, and display the list of subjects, the review progress rate and the wrong answer rate as shown in FIG. 6A in operation S502.

When the control unit 110 receives a selection of a subject for which a wrong answer note is to be generated from among the list of subjects in operation S503, the control unit 110 may receive a list of a wrong answer note of the selected subject from the learning content-providing server 200, and display the received list as shown in FIG. 6B, in operation S504.

Then, when the control unit 110 receives a selection of a list from among the wrong answer note lists from the learner in operation S505, the control unit 110 may receive information about the corresponding list from the learning content-providing server 200 and display the information about the corresponding list. The learning content-providing server 200 may provide an explanation about the wrong answer in the form of text or a video clip. When receiving an input of a question from the learner, the control unit 110 may transmit the question to the learning content-providing server 200, and receive a response to the question from the learning content-providing server 200 immediately or within a certain period of time and display the response. The control unit 100 may receive an alarm, which notifies of arrival of the response to the question, from the learning content-providing server 200 and display the alarm.

The list of the wrong answer note includes a wrong answer note according to a result of a review that is done by the learner, as shown in FIG. 6B, and respective wrong answer notes that contain wrong answers of members who are registered for the learning content application and whose scores of the review correspond to top 10%, 30%, and 50% of all the members, as shown in FIG. 6C. A wrong answer note that corresponds to a list, which is selected by the learner, may be displayed.

When receiving an input of a selection of a wrong answer note edit menu from the learner, the control unit 110 may receive the wrong answer note edit window from the learning content-providing server 200 and display the wrong answer note edit window. The control unit 110 may receive an input of a request for deletion of wrong-answered questions included in the learner's wrong answer note, and/or a request for adding wrong-answered questions included in wrong answer notes of other members to the learner's wrong answer note from the learner, and transmit the request to the learning content-providing server 200. Then, the control unit 110 may receive an updated wrong answer note from the learning content-providing server 200 and display the updated wrong answer note.

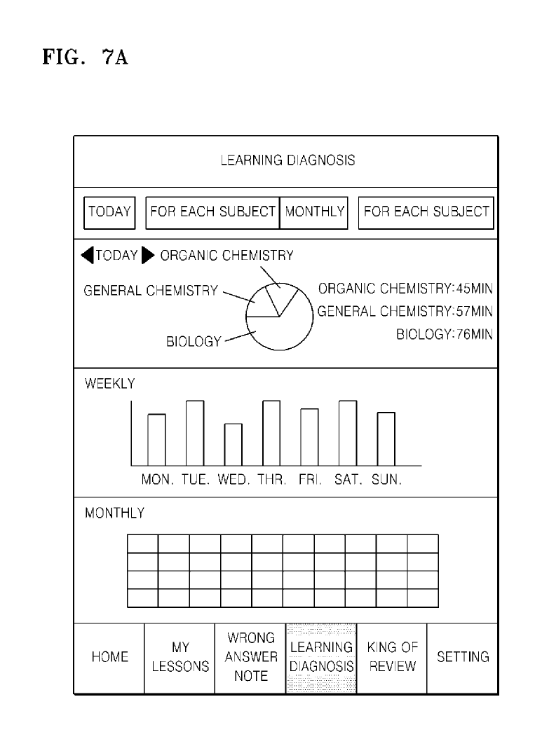

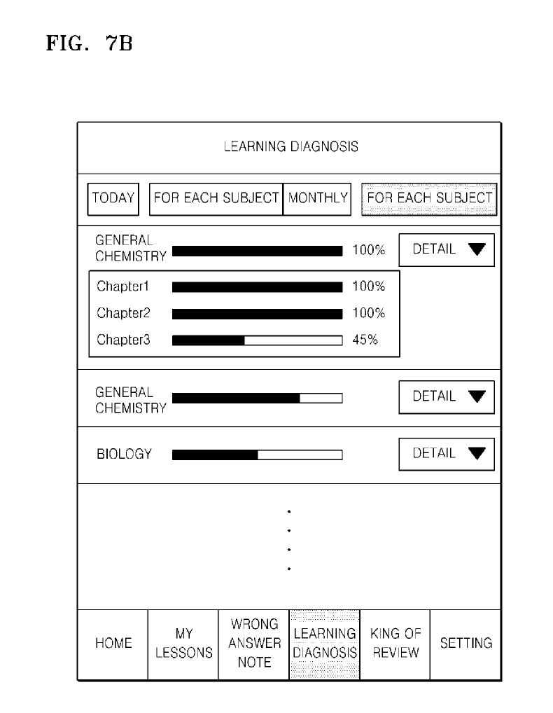

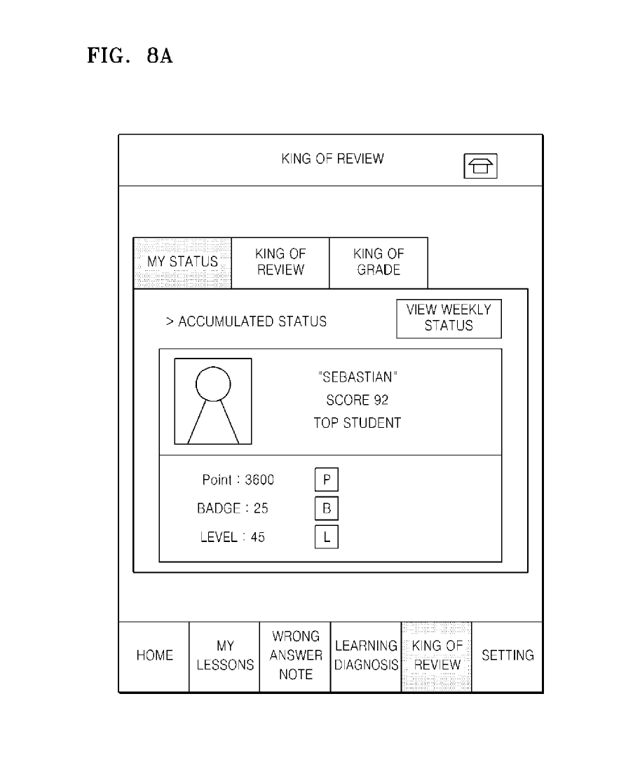

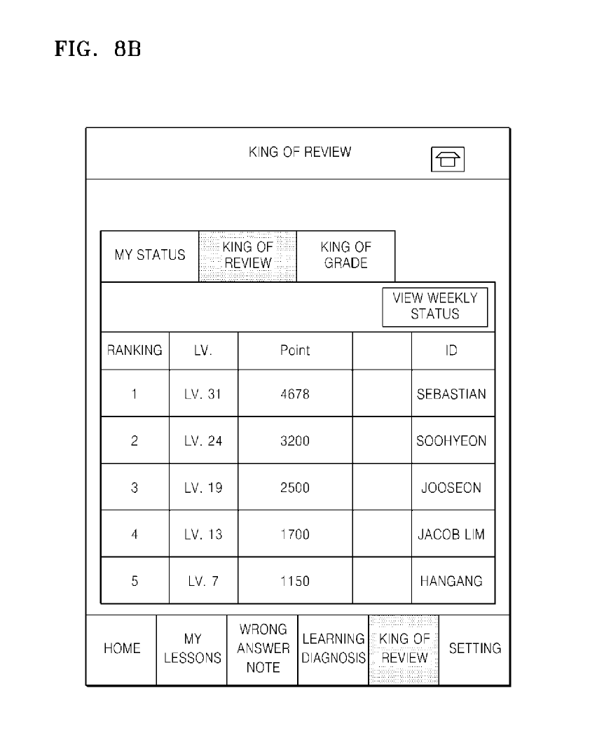

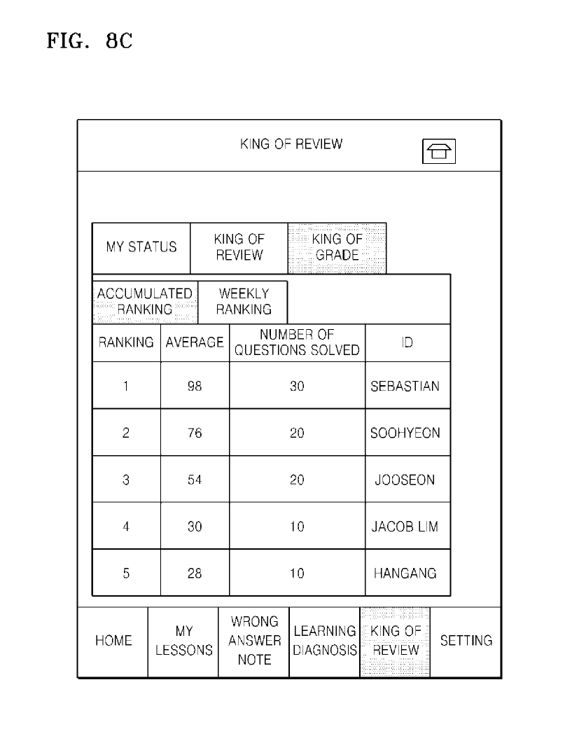

Additionally, the learner terminal 100 may perform various functions via the learning content application. Referring to FIGS. 7A and 7B, and 8A through 8C, the functions are described.

FIGS. 7A through 7B are examples of a screen in which the learner terminal 100 displays a learning diagnosis result via the learning content application according to an embodiment of the present invention.

As shown in FIGS. 7A and 7B, when receiving a selection of a learning diagnosis menu, the control unit 110 may receive a status of review that is done by the learner according to each subject, which is represented in a graph, from the learning content-providing server 200 and display the status of the review in the form of text, a graph, or a chart.

FIGS. 8A through 8C are examples of a screen in which the learner terminal 100 displays a review ranking among members of the learning content application according to an embodiment of the present invention.

As shown in FIG. 8A, when receiving a selection of a king of the review in the menu, the control unit 110 receives a total review status of the learner from the learning content-providing server 200 and displays the total review status. The review status of the learner may include a subject of which review is being done or finished, a progress rate for each subject, a total score and an average score of each subject and all the subjects, or a point score, a level, and a ranking that are obtained after the review program is performed. The review status may vary with a setting made by the manager.

Additionally, as shown in FIGS. 8B and 8C, the control unit 110 may receive a review ranking, which is obtained based on a result of reviews that are done by members who are registered for the learning content application, from the learning content-providing server 200 and display the review ranking. The review ranking may be determined by using a total sum of point scores that are provided whenever a review program is finished.

As shown in FIGS. 8B and 8C, members whose review ranking is displayed may be members in a certain range that is set by a social networking service (SNS), or members in a preset range, or members in a class or at school. The review ranking may be displayed based on point scores and levels of such members, and thus, the members may compete with or encourage each other while they do reviews.

Additionally, according to the review ranking, information such as a total average score of each member or the number of all questions that each member solved with regard to the review program may be displayed.

As such, the learners may check their review ranking, and compare their progress rate of the review program to other people's progress rate.

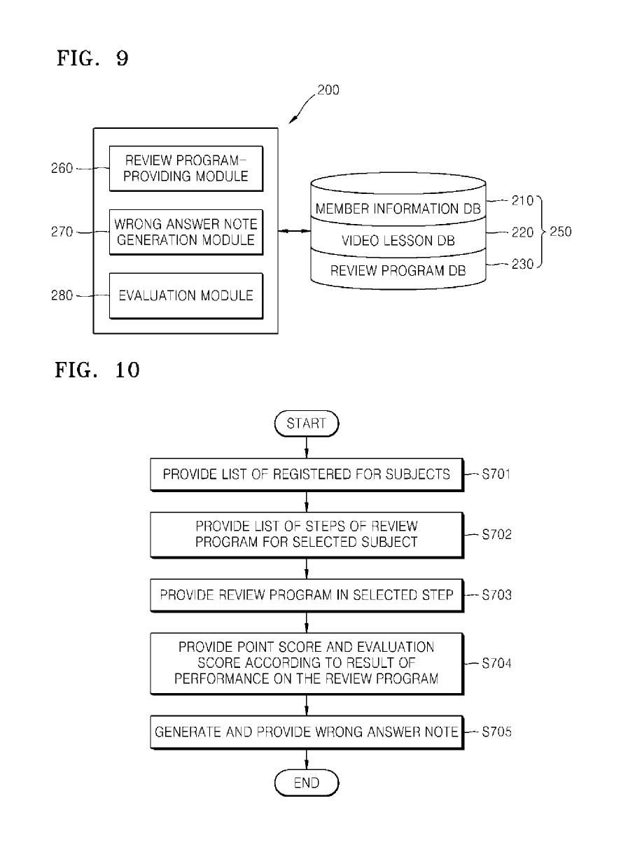

FIG. 9 is a schematic block diagram of a configuration of the learning content-providing server 200 according to an embodiment of the present invention.

The learning content-providing server 200 may be configured as hardware, software, or circuits in a computing apparatus that users access to perform the review program. A plurality of programs may be operated in one learning content-providing server 200, and according to a function of the program, one or more learning content-providing server 200 for operating the review program may be provided.

At least a part of components, which constitute the learning content-providing server 200, may be configured as software that includes at least one from among an operation system, an application program module, and another program module and, physically, stored in various types of the memory apparatus.

Additionally, the learning content-providing server 200 may be connected to a middleware for database or servers for processing payment. However, in the present invention, descriptions thereof will be omitted.

Referring to FIG. 9, the learning content-providing server 200 may include a review program-providing module 260, a wrong answer note generation module 270, and an evaluation module 280. The module herein represents a logical combination of general-use hardware and/or software.

The review program-providing module 260 may provide a list of subjects, which are registered for user information (account) to the learner terminal 100 to which login is approved. When receiving a selection with regard to a list of subjects from the learner terminal 100, the review program-providing module 260 may provide a list of steps of a review program for the selected subject. When receiving a selection of the list with regard to the steps of the review program from the learner terminal 100, the review program-providing module 260 may provide a review program in the selected step to the learner terminal 100.

For each step of the review program, a level of difficulty and an appropriate period of performing the review program may be set variously. Additionally, after a review program in a previous step is finished, for example, if an evaluation score that is obtained as a result of the performing of the previous step is equal to or higher than a reference score, the review program may be set to proceed to a next step. The learning program-providing module 260 may provide an alarm to the learner terminal 100 at an appropriate period of time that is set for each step of the review program.

The wrong answer note generation module 270 may receive a request for a wrong answer note, according to a result of performing the review program for each subject and/or step, from the learner terminal 100 and provide the wrong answer note to the learner terminal 100. The wrong answer note may include the learner's wrong answer note, which is generated based on the learner's wrong-answered questions, and other people's wrong answer notes, which are generated based on statistics of wrong-answered questions of members who are registered for the learning content-providing server 200. The other people's wrong answer notes may be generated based on questions of which a correct answer rate of the members, who are registered to the server, is low or a wrong answer rate thereof is high. Alternately, the other people's wrong answer notes may be generated based on statistics of wrong-answered questions of members whose scores are within a certain top range, for example, members whose evaluation scores are high.

Additionally, the wrong answer generation module 270 may receive a request for editing a wrong answer note from the learner terminal 100, and provide an edit window for editing the wrong answer note to the learner terminal 100. The wrong answer note generation module 270 may receive a request for deleting at least one wrong answer in the learner's wrong answer note and/or adding at least one wrong-answered question in other people's wrong answer notes. Then, the wrong answer note generation module 270 may delete and/or add a wrong-answered question that is selected from and/or to the learner's wrong answer note, and thus, update the learner's wrong answer note. The wrong answer note generation module 270 may provide the updated learner's wrong answer note to the learner terminal 100. In addition to the other people's wrong answer notes, the wrong answer note generation module 270 may provide right-answered questions and/or a question pool that includes new questions to the learner terminal 100, and receive a request for adding the right-answered questions and/or questions that are registered for the question pool from the learner terminal 100. Then, the wrong answer note generation module 270 may add the requested question to the learner's wrong answer note, and thus update the learner's wrong answer note.

The evaluation module 280 may receive a result of performing the review program for each step from the learner terminal 100, and provide a point score according to the learner's performance on the review program for each step, and an evaluation score according to a correct answer rate, to the learner terminal 100.

The point score is provided based on a degree of participation and diligence such as a period of performing the review program for each step, a number of performing the review program, and time required for performing the review program. The evaluation score is provided according to a result of grading answers that were submitted when the review program was performed.

Since a level of difficulty, required time, and an appropriate period of performing the review program are various in each step of the review program, a point score may be set variously according to a step of the review program, which is performed by the learner, a period of performing the review program for each step, and a number of performing the review program. For example, when each step of the review program is finished in a short period of time, or when each step of the review program is performed for plural times, a high point score may be provided to the learner. The point score and the evaluation score of the learner may be updated whenever performing of the review program is finished.

The evaluation module 280 may determine a review ranking of the learner according to a result in which the point scores are accumulated, and provide the review ranking to the user terminal 100.

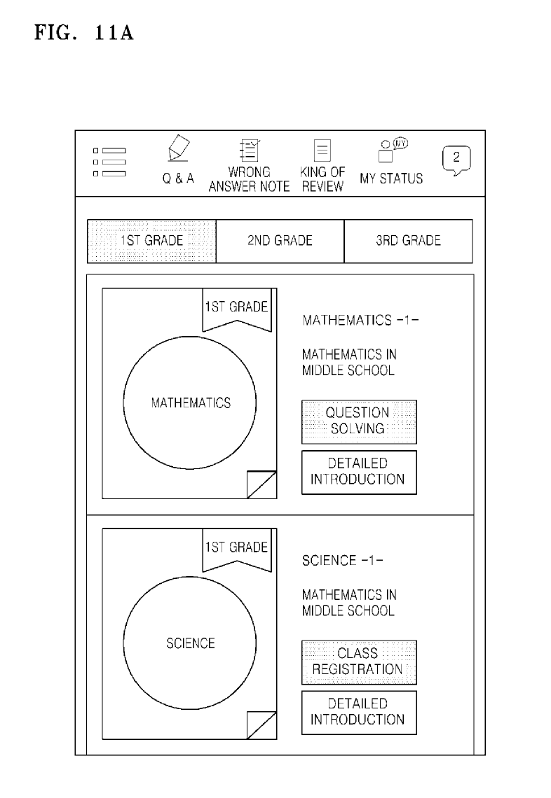

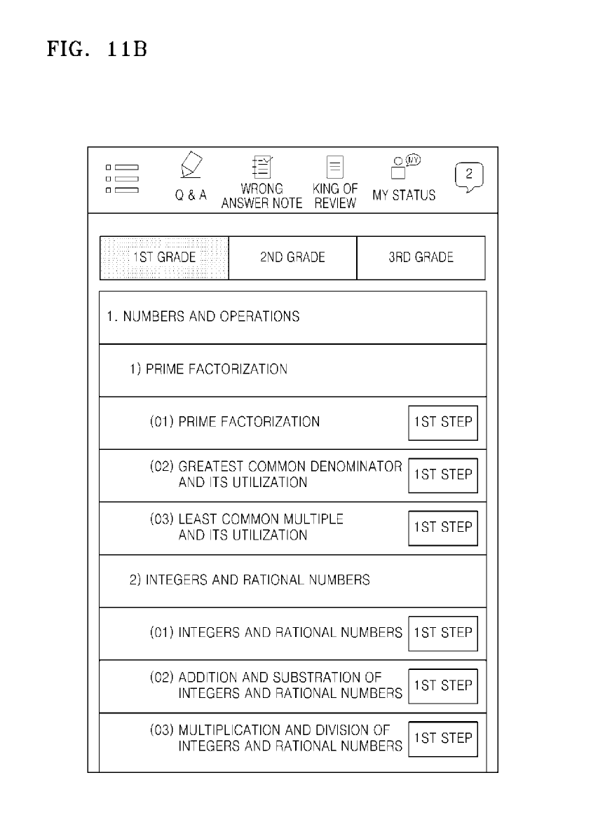

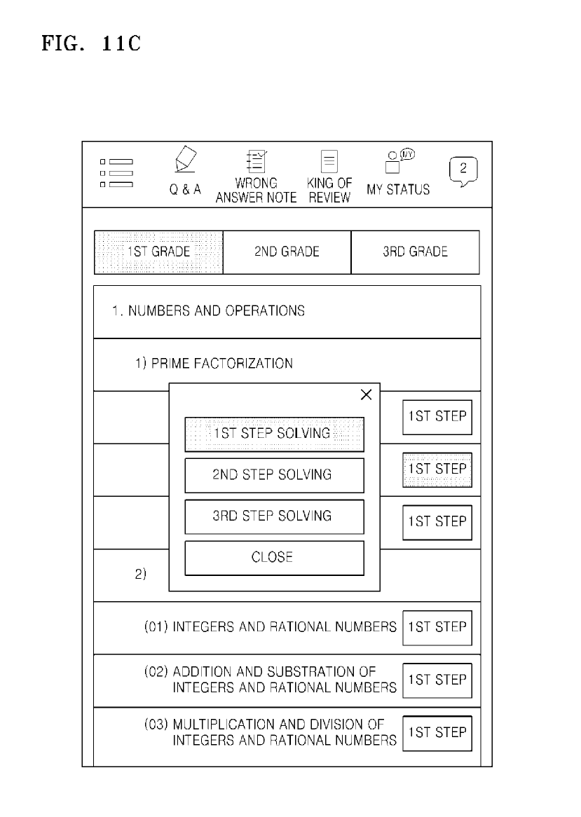

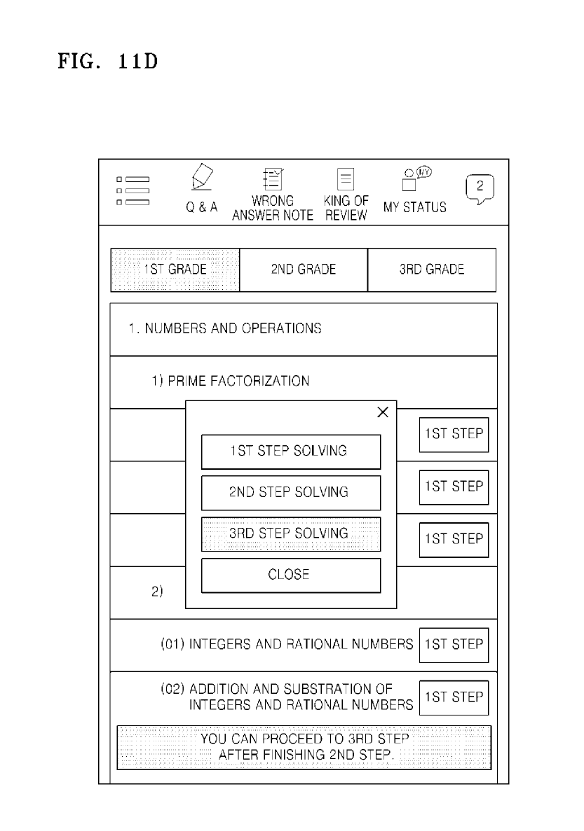

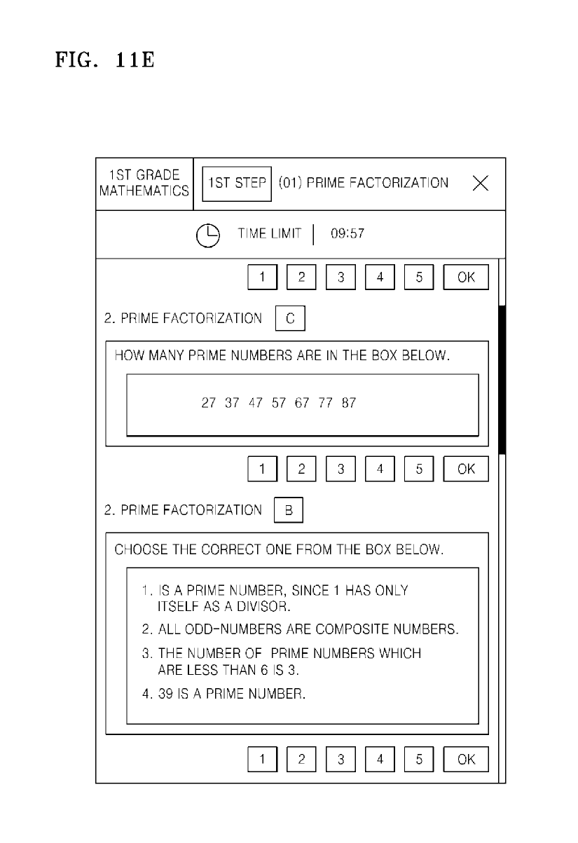

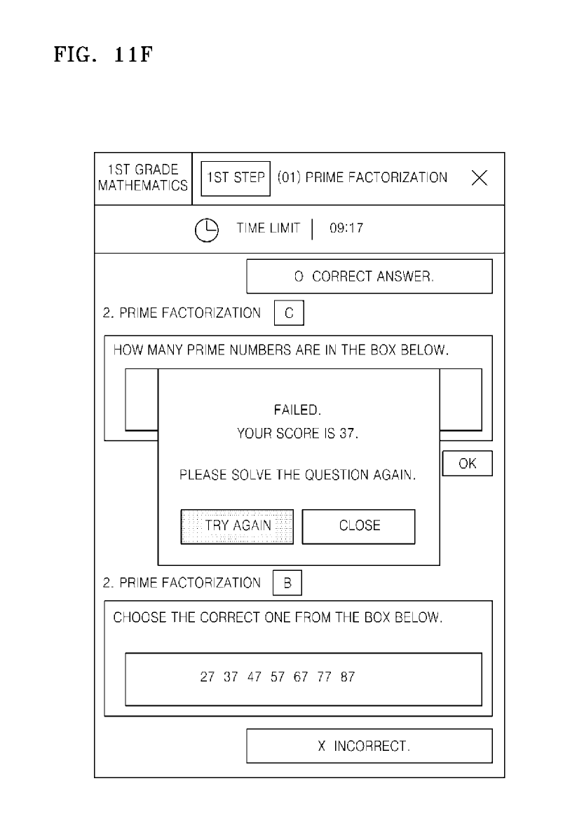

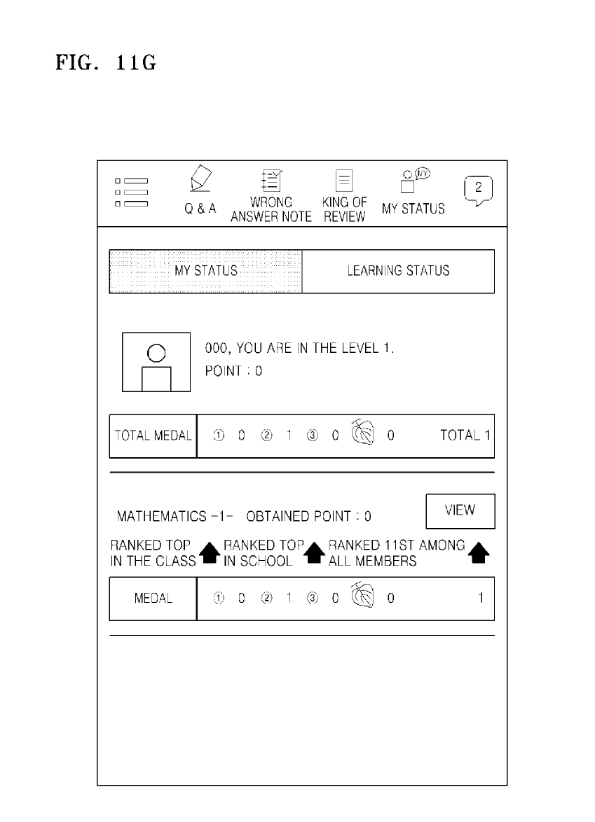

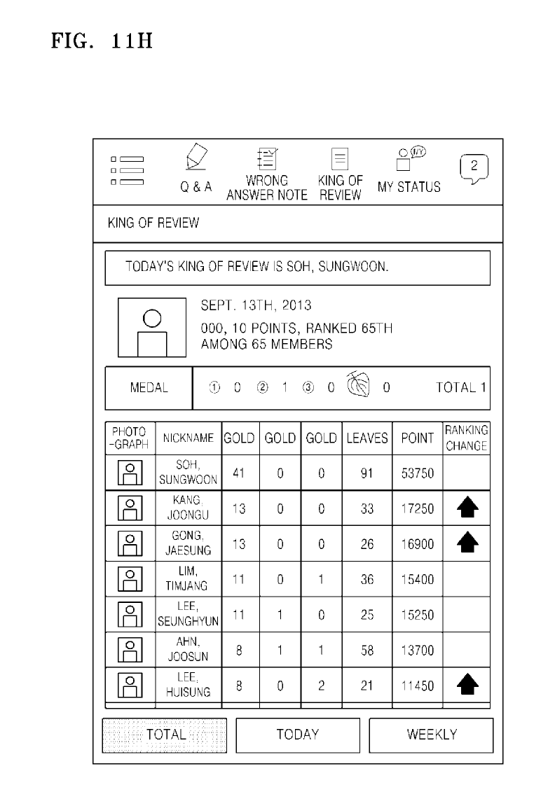

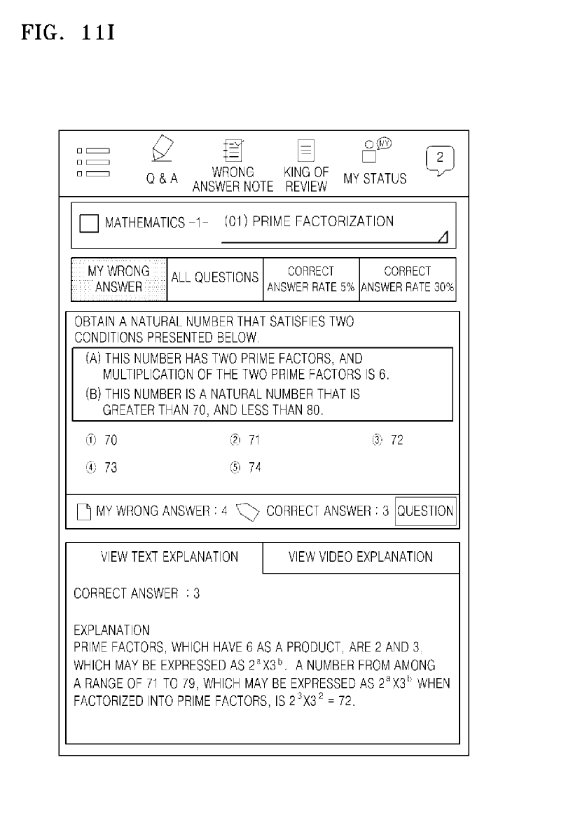

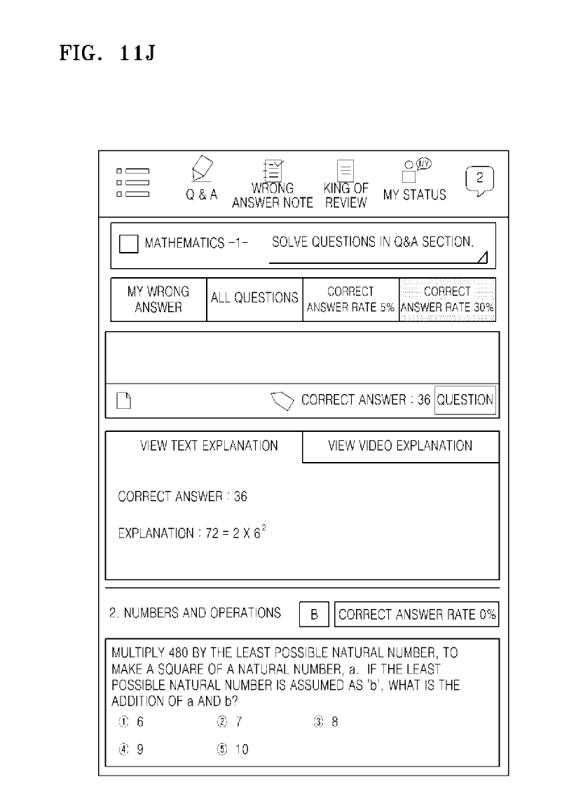

FIG. 10 is a flowchart for illustrating a method, performed by the learning content providing server 200, of providing learning contents according to an embodiment of the present invention. FIGS. 11A through 11J are examples of menu screens that are provided by the learning content-providing server 200 to the learner terminal 100.

FIGS. 11A through 11J are other examples of screens that are shown in FIGS. 4A through 4E, 6A through 6C, 7A and 7B, and 8A through 8C. Embodiments of the present invention are not limited thereto, and various types of menu screens, which provide the same functions, may be provided.

Referring to FIG. 10, in operation S701, the learning content-providing server 200 may provide a list of subjects, which are registered for user information (account), to the learner terminal 100 to which login is approved. The learning content-providing server 200 may additionally provide a list of subjects, which may be registered for, to the learner terminal 100.

FIG. 11A shows a list of subjects, which is provided by the learning content-providing server 200 and displayed on the learner terminal 100. Referring to FIG. 11A, the list of the subjects may include a list of subject that is already signed up and registered for by the learner, for example, mathematics and a list of subjects that may be signed up for by the learner, for example, science.

In operation S702, the learning content-providing server 200 may receive a selection with regard to a list of the subjects from the learner terminal 100, and provide a list of steps of the review program for the selected subject. The learning content-providing server 200 may provide the list of units of the selected subject and a step selection menu for the review program that is included in each unit.

FIGS. 11B and 11C show a list of units of the selected subject and a step selection menu for the review program that is included in each unit, which are provided by the learning content-providing server 200 and displayed on the learner terminal 100. When a unit selection menu in the list of the units is selected, the step selection menu may be provided as a menu window in which a plurality of steps, for example, one of first through third steps may be selected.

Additionally, as shown in FIG. 11D, the learning content-providing server 200 may limit proceeding to a next step, so that the next step may not be performed until the current step is finished.

In operation S703, the learning content-providing server 200 may receive a selection with regard to the list of the steps of the review program from the learner terminal 100, and provide a review program in the selected step to the learner terminal 100. The review program may include lesson contents and/or review questions for a test. The review questions may be a multiple-choice or subjective type. The learner may input an answer directly to the learner terminal 100 or input an answer by using voice or gesture recognition.

FIG. 11E shows review questions for a test as a review program in a selected step, which is provided by the learning content-providing server 200 and displayed on the learner terminal 100. As shown in FIG. 11E, a level of difficulty may be displayed for each review question, and a time limit that is provided to solve all the questions, which is included in the review program in each step, may be displayed. The learner terminal 100 may display questions on a screen as a scroll bar at one side of the screen is moved.

When OK in the menu is selected for each question, the learning content-providing server 200 may immediately provide whether an answer is right or wrong. If OK in the menu is selected after all answers are input for all the questions, the learning content-providing server 200 may provide whether all the answers to all the questions are right or wrong. The learning content-providing server 200 may regard an incorrect answer, an answer that is input after a time limit elapsed, or an answer that is not input within a time limit as a wrong answer.

Additionally, the learning content-providing server 200 may receive a question about an explanation of the wrong answer from the learner terminal 100, and provide a response to the question immediately or within a certain period of time by using a text message or an e-mail. The learning content-providing server 200 may provide an alarm for notifying of arrival of the response to the question.

In operation S704, the learning content-providing server 200 may receive a result of performing the review program from the learner terminal 100, and provide a point score according to the learner's performance on the review program for each step, and an evaluation score according to a correct answer rate to the learner terminal 100. The learning content-providing server 200 may determine a review ranking of the learner, according to a result in which the point scores are accumulated, to the user terminal, and provide the review ranking to the learner terminal 100.

FIG. 11F shows a screen in which the learning content-providing server 200 provides an evaluation score according to a result of performing the review program in a specific step to the learner terminal 100. If the evaluation score according to a result of performing the review program in each step is less than a reference score, the learning content-providing server 200 may provide an alarm so that the learner may re-perform the corresponding step of the review program.

FIG. 11G is a screen in which the learning content-providing server 200 integrates a result of performing the review program for each step and provides a point score and a level to the learner terminal 100. As shown in FIG. 11G, the learning content-providing server 200 may provide a point score according to a degree of performing, by the learner, the review program so far and determine a ranking and a level according to the point score. For example, whenever each step of the review program is performed, a certain number of leaves are provided, and if plural steps, for example, all three steps are finished, a medal may be provided. A medal is classified into gold, silver, and bronze. A different type of medal may be provided for each step of the review program, based on a degree of the learner's participation and diligence such as a period of performing the review program, a number of performing the review program, and time required for performing the review program for each step of the review program. A point score is variously set according to a type of medal, and a point score may be totaled and displayed according to a result of a type and number of obtained medals. A point score, which is provided whenever the review program is performed, may be accumulated and displayed for each subject or for all subjects.

FIG. 11H is a screen in which the learning content-providing server 200 provides a ranking that is determined based on a point score and a level of the learner to the learner terminal 100. As shown in FIG. 11H, the learning content-providing server 200 may determine a review ranking and a level of a member according to a point score, which is provided and accumulated to the member based on a result of performing, by the member, the review program for a certain period of time such as a day, a week, or a month. The review ranking may be frequently updated according to a degree in which the members performed the review program.

In operation S705, the learning content-providing server 200 may receive a request for a wrong answer note according to a result of performing each step of the review program from the learner terminal 100, and then, generate and provide a wrong answer note to the learner terminal 100. The wrong answer note may include the learner's wrong answer note, or other people's answer notes according to statistics on a result in which members who are registered for the learning content-providing server 200 perform the review program for each step. The learner terminal 100 may transmit a request for a wrong answer note for each unit and/or step according to the learner's need, and receive the wrong answer note from the learning content-providing server 200 and display the wrong answer note.

FIG. 11I shows a screen in which the learning content-providing server 200 provides the learner's wrong answer note to the learner terminal 100. The learning content-providing server 200 may also provide an answer note for all questions that include wrong-answered questions and right-answered questions.

Additionally, as shown in FIG. 11J, the learning content-providing server 200 may provide other people's wrong answer notes in which a result of performing, by other members, the review program. For example, the learning content-providing server 200 may provide a wrong answer note, which is generated based on questions of which correct answer rate of the members is within 5% or 30%, or a wrong answer note, which is generated based on wrong-answered questions of the members whose grade (evaluation point) is in top 5% or 30%.

Additionally, when receiving a request for editing a wrong answer note from the learner terminal 100, the learning content-providing server 200 may provide a menu in which a wrong-answered question in the learner's wrong answer note may be deleted or a wrong-answered question in other people's wrong answer notes may be added. The learning content-providing server 200 may receive a selection of at least one wrong-answered question to be deleted or added from the learner terminal 100, and delete the selected wrong-answered question from the learner's wrong answer note or add the selected wrong-answered question to the learner's wrong answer note, thus updating the wrong answer note. Additionally, the learning content-providing server 200 may provide a menu for editing or updating the wrong answer note. As examples, the menu can be designed to add the learner's wrong-answered question, right-answered question, and a new question to the learner's wrong answer note, thus updating the wrong answer note.

As described above, according to the one or more of the above embodiments of the present invention, achievements of a learner may be improved by encouraging the learner to do a review of each unit simply, systematically, and repeatedly at a certain interval regardless of time and place by using a portable terminal, after taking an offline or online lesson in each unit for each subject.

Additionally, after the learner performed a review by using the portable terminal, wrong-answered questions are collected and thus, a wrong answer note is generated. Thus, the learner may study the wrong-answered question repeatedly after performing a review. Additionally, a question with a high wrong answer rate (for example, higher than 30%) of a higher scorer among learners who studied a subject and a unit, for example, a learner with a score in a top 10% is automatically collected, and a wrong answer note of the high scorer is generated. Thus, the learner may additionally compare the wrong answer note when studying, and an efficiency of repeated learning may be maximized.

In addition, other embodiments of the present invention can also be implemented through computer readable code/instructions in/on a medium, e.g., a computer readable medium, to control at least one processing element to implement any above described embodiment. The medium can correspond to any medium/media permitting the storage and/or transmission of the computer readable code.

The computer readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as Internet transmission media. Thus, the medium may be such a defined and measurable structure including or carrying a signal or information, such as a device carrying a bitstream according to one or more embodiments of the present invention. The media may also be a distributed network, so that the computer readable code is stored/transferred and executed in a distributed fashion. Furthermore, the processing element could include a processor or a computer processor, and processing elements may be distributed and/or included in a single device.

It should be understood that the exemplary embodiments described therein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes in form and details may be made therein without departing from the spirit and scope of the present invention as defined by the following claims.

What is claimed is:

1. A method of providing learning contents by a server, the method comprising:
providing a list of steps of review contents to a user terminal;
receiving from the user terminal a selection of a step from the list of the steps of the review contents;
providing the review contents of the selected step to the user terminal; and
providing a point score according to a learning performance on each step of the review contents by a user and an evaluation score according to a correct answer rate to the user terminal.

2. The method of claim 1, further comprising setting a plurality of difficulty levels and learning periods of at least one of the steps of the review contents.

3. The method of claim 1, wherein each step of the review contents is performable after the review contents of a previous step have been learned.

4. The method of claim 2, further comprising providing an alarm to the user terminal in the set plurality of learning periods.

5. The method of claim 1, wherein the steps of the review contents are displayed as a plurality of icons according to whether learning has been performed and the learning performance.

6. The method of claim 1, wherein the point score is calculated based on a period of learning the review contents of each step, and a number of times that the review contents are learned.

7. The method of claim 1, wherein the providing of the point score comprises providing a review ranking of the user determined according to a result of accumulated point scores to the user terminal.

8. The method of claim 1, further comprising receiving a request for my wrong answer note or at least one of other people's wrong answer notes based on results of learning review programs by members registered to the server from the user terminal, and providing my wrong answer note or the at least one of other people's wrong answer notes to the user terminal.

9. The method of claim 8, wherein the at least one of other people's wrong answer notes is generated based on questions each of which a correct answer rate of the members registered to the server is within a certain range, or wrong answer questions of the members whose evaluation scores are within a certain range.

10. The method of claim 8, wherein the providing of my wrong answer note or the at least one of other people's wrong answer notes comprises receiving a request to delete a wrong answer question from my wrong answer note or to add a wrong answer question of the at least one of other people's wrong answer notes to my wrong answer note, from the user terminal, and updating my wrong answer note by deleting or adding the requested wrong answer question from or to my wrong answer note.

11. A learning content-providing apparatus, comprising:
a review program-providing module for providing a list of steps of review contents to a user terminal, receiving from the user terminal a selection of a step from the list of the steps of the review contents, and providing review contents of the selected step to the user terminal; and
an evaluation module for providing a point score according to a learner's learning performance on each step of the review contents, and an evaluation score according to a correct answer rate to the user terminal.

12. The learning content-providing apparatus of claim 11, wherein difficulty levels and learning periods of at least one of the steps of the review contents are differently set.

13. The learning content-providing apparatus of claim 11, wherein each step of the review contents is performable after the review contents of a previous step have been learned.

14. The learning content-providing apparatus of claim 12, wherein the review program-providing module provides an alarm to the user terminal in the set learning periods.

15. The learning content-providing apparatus of claim 11, wherein the steps of the review contents are displayed as a plurality of icons according to whether learning has been performed and the learning performance.

16. The learning content-providing apparatus of claim 11, wherein the point score is calculated based on a period of learning the review contents of each step, and a number of times that the review contents are learned.

17. The learning content-providing apparatus of claim 11, wherein the evaluation module determines a review ranking of the learner according to a result of accumulated point score, and provides the review ranking to the user terminal.

18. The learning content-providing apparatus of claim 11, further comprising a wrong answer note generation module for receiving from the user terminal a request for my wrong answer note, or at least one of other people's wrong answer notes that is based on results of learning review programs by members who are registered to the server, and providing my wrong answer note or the at least one of other people's wrong answer notes to the user terminal.

19. The learning content-providing apparatus of claim 18, wherein the at least one of other people's wrong answer notes is generated based on questions each of which a correct answer rate of the members registered to the server is within a certain range, or wrong answer questions of the members whose evaluation scores are within a certain range.

20. The learning content-providing apparatus of claim 18, wherein the wrong answer note generation module receives from the user terminal a request for deleting a wrong answer question from the my wrong answer note or adding a wrong answer question of the at least one of other people's wrong answer notes to the my wrong answer note, and updates the my wrong answer note by deleting or adding the requested wrong answer question from or to the my wrong answer note.
